(19) United States
(12) Patent Application Publication
(10) Pub. No.: US 2007/0155364 A1
(43) Pub. Date: Jul. 5, 2007

(54) Method and system for content based obligation enforcement in an electronic equipment

(76) Inventor: Stefan Andersson, Klagerup (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/333,931

(22) Filed: Jan. 18, 2006

Related U.S. Application Data
(60) Provisional application No. 60/755,756, filed on Jan. 3, 2006.

(51) Int. Cl. H04M 3/16

(52) U.S. Cl. 455/410; 455/550.1

(57) ABSTRACT

A method of managing content in a portable electronic equipment includes receiving content with the portable electronic equipment. The content has a use restriction that is liftable by user action with the portable electronic equipment to satisfy a user obligation associated with the content. The method includes receiving input from the user consistent with the user action to satisfy the user obligation and lifting the use restriction to give the user access to the content, the lifting carried out by the portable electronic equipment upon satisfaction of the user obligation.

### RELATED APPLICATION DATA

The present application claims the benefit of U.S. Provisional Application Ser. No. 60/755,756, filed Jan. 3, 2006, the disclosure of which is herein incorporated by reference in its entirety.

### TECHNICAL FIELD OF THE INVENTION

The present invention relates generally to electronic equipment for engaging in voice communications and, more particularly to a method and system for enforcing content based user obligations in such electronic equipment.

### DESCRIPTION OF THE RELATED ART

Electronic equipment that provide for voice communication are becoming increasingly popular. In addition, the features associated with the electronic equipment have become increasingly diverse. To name a few examples, many electronic equipment include cameras, Internet browsing functionality, video playback capability, audio playback capability, image display capability and hands-free headset interfaces.

The electronic equipment can include a memory used to store data, address book or contact information, ring tones, video clips, audio clips, image files and so forth. These items and any other types of items stored by the memory are typically arranged in files and will be referred to herein as content.

The content is produced by a content generator, sometimes referred to as an author. The content, or an electronic copy of the content, can be transmitted to the electronic equipment directly by the content generator or through another person or entity referred to as a content provider. Content providers can be a network service provider that provides wireless communications services to the electronic equipment, another electronic equipment, and so forth.

The content generator and/or the content provider may desire that the user have limited access to the content. For example, the content may have a restriction that allows the content to be played a limited number of times or that a license is required to use the content.

Some content control schemes have been referred to as digital rights management (DRM). Conventional DRM schemes that control content with a license have required the user to subscribe to a service. The user may be required to pay a service fee, such as a monthly or yearly payment, and/or pay for content on a content item by content item basis. Managing user accounts for these services involves the dedication of resources by the service provider. The conventional service based DRM schemes are client-server oriented, meaning that specified interaction between the electronic equipment acting as the client device and a server of the service provider must take place to acquire the content or a license for the content. Furthermore, the user has the responsibility of managing their account with the service provider and remembering passwords. In addition, the user may need to release personal information to join the service, including credit card information, which may hinder widespread user adoption of the service.

### SUMMARY

In view of the aforementioned shortcomings associated with existing content control techniques, there is a need in the art for a content management scheme that does not suffer from such drawbacks. More particularly, there is a need in the art for a method and system for enforcing content based user obligations in user operated electronic equipment.

According to one aspect of the invention, a method of managing content in a portable electronic equipment includes receiving content with the portable electronic equipment, the content having a use restriction that is liftable by user action with the portable electronic equipment to satisfy a user obligation associated with the content; receiving input from the user consistent with the user action to satisfy the user obligation; and lifting the use restriction to give the user access to the content, the lifting carried out by the portable electronic equipment upon satisfaction of the user obligation.

According to another aspect, the portable electronic equipment has wireless communication capability and a memory for storing the content.

According to another aspect, the portable electronic equipment is a mobile telephone.

According to another aspect, the user action is the transmission of a text message.

According to another aspect, the text message has a particular content and is transmitted to a particular destination to satisfy the obligation.

According to another aspect, the user action is the generation of a data call.

According to another aspect, the user action is the entry of an access code.

According to another aspect, the access code is acquired by the user upon the purchase of an item.

According to another aspect, the item is the content received by the portable electronic equipment.

According to another aspect, the item is merchandise acquired by the user separately from the content.

According to another aspect, the user action is submission of a payment.

According to another aspect, the payment submission includes making a short range transmission associated with a local payment scheme.

According to another aspect, the user action is transmission of the content from the portable electronic equipment to another electronic equipment.

According to another aspect, the user action is playing back another content associated with the content having the use restriction.

According to another aspect, the user action is taking a photograph with the portable electronic equipment.

According to another aspect, the method further includes prompting the user for the input upon an attempt by the user to access the content.

According to another aspect, the method further includes deleting the content if the user does not enter the input or declines to enter the input following prompting of the user.

According to another aspect, the prompting provides the user with a choice of plural actions to satisfy the obligation.

According to another aspect, the method further includes executing a plug-in to manage the user obligation.

According to another aspect, the method further includes using a SIM card to satisfy the user obligation.

According to another aspect, satisfying the user obligation lifts the use restriction indefinitely.

According to another aspect, the method further includes imposing the user obligation each time the user attempts to access the content.

According to another aspect, the method further includes imposing the user obligation during use of the content or periodically to permit continuing user access to the content.

According to another aspect of the invention, a portable electronic equipment includes a user input device and a memory that contains a content having a data structure. The data structure includes a file containing at least one of audio data, video data, text data or executable instructions and a use restriction liftable by the portable electronic equipment upon receipt of user input via the user input device and that satisfies a user obligation associated with the content.

According to another aspect of the invention, a program stored on a machine usable medium includes a content obligation enforcement function for a portable electronic equipment having a memory for storing content. The program includes executable logic to receive content with the portable electronic equipment, the content having a use restriction that is liftable by user action with the portable electronic equipment to satisfy a user obligation associated with the content; prompt the user for the user action; and lift the use restriction upon user action to satisfy the user obligation to give the user access to the content.

According to another aspect, the portable electronic equipment is a mobile telephone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile telephone as an exemplary electronic equipment in accordance with an embodiment of the present invention;

FIG. 2 is a schematic block diagram of the relevant portions of the mobile telephone of FIG. 1 in accordance with an embodiment of the present invention; and

FIG. 3 is a flow chart of an exemplary obligation enforcement scheme carried out by the mobile telephone in accordance with an embodiment of the present invention.

### DETAILED DESCRIPTION OF EMBODIMENTS

The present invention will now be described with reference to the drawings, wherein like reference numerals are used to refer to like elements throughout.

The term “electronic equipment” includes portable radio communication equipment. The term “portable radio communication equipment,” which herein after is referred to as a “mobile radio terminal,” includes all equipment such as mobile telephones, pagers, communicators, i.e., electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of electronic equipment.

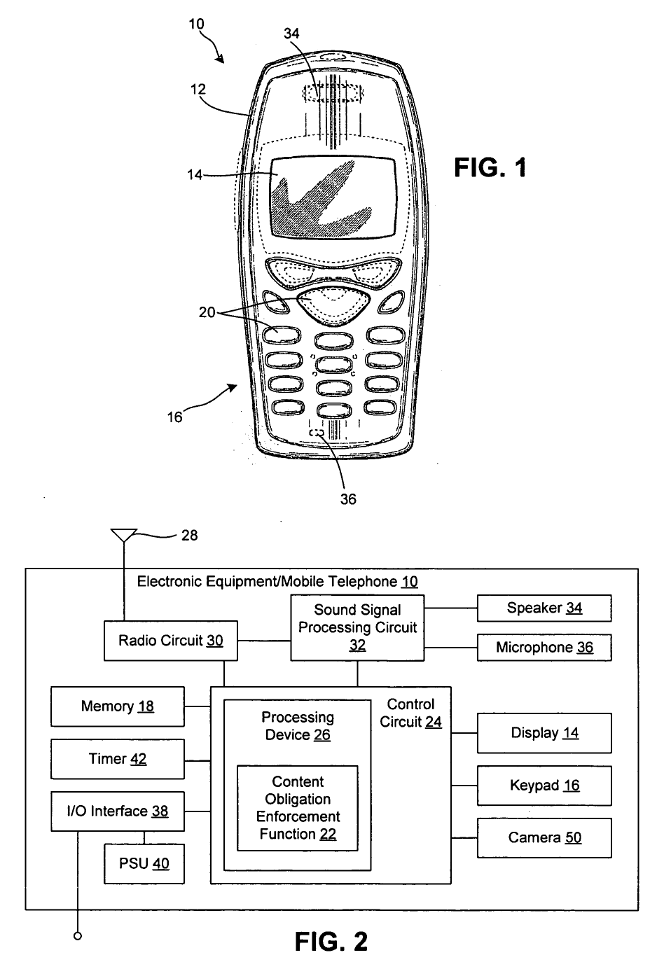

Referring initially to FIG. 1, an electronic equipment 10 is shown in accordance with the present invention. The electronic equipment includes a content obligation enforcement function that is configured to restrict access to or use of the content until the user of the electronic equipment 10 has satisfied the obligation. It will be appreciated, that the content obligation enforcement function may be embodied as executable code resident in the electronic equipment 10 or as part of the content itself, or a combination of a resident function and a content associated function.

In the exemplary embodiment described herein, the electronic equipment is a mobile telephone and will be referred to as the mobile telephone 10. The mobile telephone 10 is shown as having a “brick” or “block” design type housing 12, but it will be appreciated that other type housings, such as a clamshell housing or a slide-type housing, may be utilized without departing from the scope of the invention.

The mobile telephone 10 includes a display 14 and keypad 16. As is conventional, the display 14 displays information to a user such as operating state, time, telephone numbers, contact information, various navigational menus, etc., which enable the user to utilize the various feature of the mobile telephone 10. The display 14 may also be used to visually display content received by the mobile telephone 10 and/or retrieved from a memory 18 (FIG. 2) of the mobile telephone 10.

Similarly, the keypad 16 may be conventional in that it provides for a variety of user input operations. For example, the keypad 16 typically includes alphanumeric keys 20 for allowing entry of alphanumeric information such as telephone numbers, phone lists, contact information, notes, etc. In addition, the keypad 16 typically includes special function keys such as a “call send” key for initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone may include a volume key, audio mute key, an on/off power key, a web browser launch key, a camera key, etc. Keys or key-like functionality may also be embodied as a touch screen associated with the display 14.

As will become more apparent in view of the following description, the mobile telephone 10 overcomes the aforementioned shortcomings associated with existing electronic equipment. Specifically, the mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc.

FIG. 2 represents a functional block diagram of the mobile telephone 10. With the exception of a content obligation enforcement function 22 according to the present invention, which is preferably implemented as executable logic in the form of application software or code within the mobile telephone 10, the construction of the mobile telephone 10 is otherwise generally conventional. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory within the control circuit 24 (not shown) and/or in a separate memory, such as memory 18, in order to carry out conventional operation of the mobile telephone 10. The memory 18 can be, for example, a buffer, a flash memory, a hard drive, a removable media, a volatile memory and/or a non-volatile memory. In addition, the processing device 26 executes code in accordance with the present invention in order to perform the content obligation enforcement function 22.

It will be apparent to a person having ordinary skill in the art of computer programming, and specifically in applications programming for mobile telephones, how to program a mobile telephone 10 to operate and carry out the functions described herein. Accordingly, details as to the specific programming code have been left out for sake of brevity. Also, while the content obligation enforcement function 22 is executed by the processing device 26 in accordance with the preferred embodiment of the invention, such functionality could also be carried out via dedicated hardware, firmware, software, or combinations thereof, without departing from the scope of the invention. In addition, corresponding and complementary functions of a remote server (not shown) that interacts with mobile telephone 10 can be embodied as executable logic that is stored by a memory of that device and/or is executed by a processor of that device.

Continuing to refer to FIGS. 1 and 2, the mobile telephone 10 includes an antenna 28 coupled to a radio circuit 30. The radio circuit 30 includes a radio frequency transmitter and receiver for transmitting and receiving signals via the antenna 28 as is conventional. The mobile telephone 10 further includes a sound signal processing circuit 32 for processing the audio signal transmitted by/received from the radio circuit 28. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation.

The mobile telephone 10 also includes the aforementioned display 14 and keypad 16 coupled to the control circuit 24. The mobile telephone 10 further includes an I/O interface 38. The I/O interface 38 may be in the form of typical mobile telephone I/O interfaces, such as a multi-element connector at the base of the mobile telephone 10. As is typical, the I/O interface 38 may be used to couple the mobile telephone 10 to a battery charger to charge a power supply unit 40 within the mobile telephone 10. In addition, or in the alternative, the I/O interface 38 may serve to connect the mobile telephone 10 to a wired personal hands-free adaptor (not shown) or a local wireless interface (e.g., a Bluetooth adaptor (not shown) for use with a Bluetooth-based hands-free adaptor). Further, the I/O interface 38 may serve to connect the mobile telephone 10 to a personal computer or other device via a data cable or wireless link, etc.

The mobile telephone 10 may also include a timer 42 for carrying out timing functions. Such functions may include timing the durations of calls, etc.

The mobile telephone 10 can be configured to operate in a communications system (not illustrated). The system can include a server or servers for managing calls placed by and destined to the mobile telephone 10, transmitting content to the mobile telephone 10 and carrying out any other support functions. The server communicates with the mobile telephone 10 via a network and a transmission medium. The transmission medium can be any appropriate device or assembly, including, for example, a communications tower, another mobile telephone, a wireless access point, a satellite, etc. Portions of the network may include wireless transmission pathways.

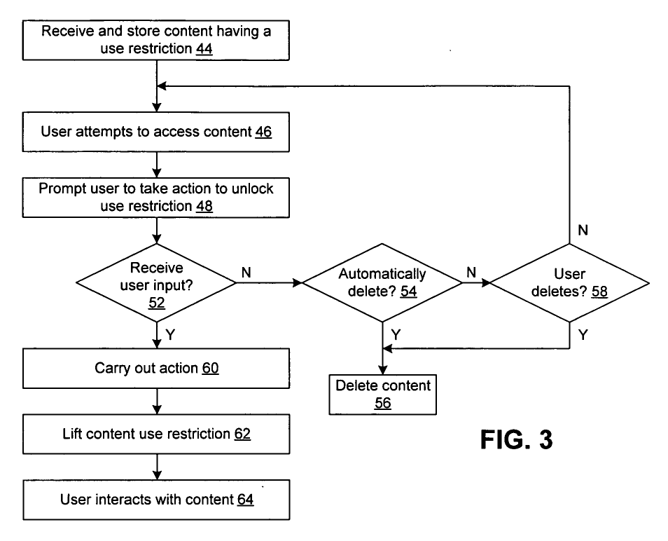

Referring to FIG. 3, an obligation based method of content management carried out by the mobile telephone 10 is depicted. The method can be embodied as executable code, such as in the form of the content obligation enforcement function 22 or a portion of code associated with the content.

The method starts in block 44 where the mobile telephone 10 receives content having a use restriction, which also may be referred to as a constraint or other appropriate term. Upon receipt, the content may be stored in the memory 18. The content can be in any appropriate form, such as a data file, an audio file, a ring tone, a video file, an image file, an executable file, a game, a combination of file types or the like. The content may be pushed to or pulled by the mobile telephone 10, downloaded by user action or received by any other suitable technique. The source of the content can be any suitable device, including the server of the communications system, another item of electronic equipment (e.g., another mobile telephone), a general purpose computer, etc.

Following receipt, the user may attempt to access the content in block 46. The manner in which content is accessed may depend on the type of content. For example, if the content is an audio file (e.g., a song embodied as a sound recording) or ring tone, the content may be played back by the mobile telephone 10 through the speaker 34. If the content is a video or image file, the content may be displayed on the display 14 and any audio component of the file may be broadcast by the speaker 34. Executable files may be passed to the processing device 26 for execution.

As indicated, the content may have a user obligation associated with the content. The obligation may obligate the user to carry out some action before being given full or partial access to the content. For example, if the content is an audio file, the user may not be able to playback the content until the action specified by the obligation is completed.

Therefore, in block 46, the user may not gain full access to the content if the obligation has not been satisfied. According, to assist the user in satisfying the obligation and gaining access to restricted content (e.g., any or all of the content), the method can proceed to block 48. In block 48, the user is prompted to undertake the action specified by the obligation associated with the content. The action will typically involve having the user make an input to the mobile telephone 10, such as by making keystrokes with the keypad 16, speaking into the microphone 36, etc. In one embodiment, the user may have a choice among several actions to satisfy the obligation.

Actions to satisfy the obligation associated with the content can vary. In one embodiment, the action can be sending a text message (e.g., a short message service (SMS) format transmission) to a specified recipient designated by a phone number, network address, URL, electronic mail address or the like. The content of the text message could be used to identify a known user to the recipient so that the user could be charged or credited in an appropriate manner for using the content. Other actions can include sending a data call, sending registration information, or other transmission.

In other embodiments, the user could be prompted to enter a validation code or other information used to authenticate the user, the mobile telephone 10 or the content. For example, content may be sold or associated with an access code or decryption key. Upon entry of the proper input, the content may become unlocked. For example, a user may be able to download certain content having a use restriction that can be lifted by entry of a valid access code. The access code may be acquired by a user action. For example, the action to acquire the access code may be purchasing an item. The access code, for example, could be printed on the underside of a bottle cap or inside packaging for an item.

Another example action can be transmitting the content to a specified number of other devices (e.g., items of electronic equipment, electronic mail addresses, etc. Another example action can be the viewing or listening to a commercial or advertisement. Another example action can be transmitting a picture or image file taken by a camera 50 (FIG. 2) of the mobile telephone 10 at the time of prompting in block 48. Another example action can be accepting a license or end user agreement.

In other embodiments, the action may be an action that results in payment for the content. The payment can be made in a legal tender amount (i.e., government issued notes) or in “virtual” cash (i.e., credits accumulated by the user and issued by a particular vendor or entity). Therefore, the action may be paying by credit or debit card, paying by a payment service (e.g., PAYPAL™) or wire transfer, or charging paying to an account. In one embodiment, the user may opt out of paying for the content by undertaking another action, such as listening to or viewing an advertisement. Payment may be made using a local payment scheme where the mobile telephone 10 uses a short range transmission (e.g., under a radio frequency identification (RFID) protocol) to communicate with a corresponding reader or interface adapter located in close proximity (e.g., a few feet to about 30 years) to the mobile telephone to render payment.

The decision to complete the specified task can be made at the time of prompting in block 48. Accordingly, if the user decides not to or declines to take the specified action in block 52 (e.g., a negative determination is made), the method can proceed to block 54. Some obligations associated with content may specify that the content is to be deleted from the memory 18 if the user decides not to take the specified action. Therefore, block 54 may determine whether the content is to be automatically deleted, in which case the method will proceed to block 56 where the content is deleted. Otherwise, the method may proceed to block 58 where the user may be asked if the user would like to delete the content. If the user would like to delete the content, the content can be deleted in block 56. If a negative determination is made in block 58, the method can return to before block 46 where the method can wait until the user again attempts to access the content.

If the user undertakes the action that will satisfy the obligation by making a corresponding input to the mobile telephone 10, a positive determination can be made in block 52. If a positive determination is made in block 52, the mobile telephone 10 can perform steps to carry out any machine based portions of completing the action in block 60. For instance, the user may enter the contents of a text message in block 52 and the mobile telephone 10 can transmit the message in block 60. Alternative, the mobile telephone 10 can act upon an entered access code, playback an advertisement, etc.

In some embodiments, the content may install and/or make a software call to a plug-in module (e.g., a JAVA script) to assist in managing the user obligation. The plug-in module could assist in carrying out the functions associated with the method and increase the types of user obligations associated with the content. In still other embodiments, a subscriber identity module (SIM) card may be used in connection with satisfying the user obligation. For instance, a JAVA application could be resident on a SIM card that is associated with the mobile telephone 10 to manage the user obligation, provide enhanced security to a payment scheme or the like.

Thereafter, in block 62, the use restriction imposed by the obligation can be “unlocked”, such as by permanently or temporarily lifting of the obligation. If permanently lifted, any subsequent attempts to access the content will allow direct access to the content. If temporarily lifted, subsequent attempts to access the content may obligate the user to complete the specified action again or undertake a different action. The use restriction associated with the content may be used by the content author or content provider to determine when and/or how many times the user obligation is to be satisfied to allow access to the content. For instance, satisfying the user obligation once will allow the user to access the content indefinitely. In other cases, each time the user attempts to access the content, the user obligations may be imposed. In other cases, the user obligation may be imposed at predetermined intervals (e.g., monthly) or upon a content use based scheme. For instance, the user obligation may be imposed as the user uses the content, such as to gain continuing access to a game, a video transmission (e.g., impose a payment obligation for every five minutes of a television show), etc.

Lifting of the content use restriction is made by the mobile telephone 10 upon completion of all user and machine based actions to satisfy the obligation. In some embodiments where data is transmitted by the mobile telephone 10 as part of satisfying the obligation associated with the content, lifting of the content use restriction can be deferred until a confirmation is received from the recipient of the transmission.

Upon lifting of the use restriction in block 62, the user is given access to the content in block 64 where the user may interact with the content as appropriate for the content (e.g., listen to and/or view the content, work with a data file, play a game, etc.).

In a variation to the method described above, the mobile telephone 10 can receive an indication that content is available. Associated with the indication may be data concerning any obligations for which the user and/or the mobile telephone 10 are to satisfy before acquiring the content. Once those actions are carried out, the content may be received (e.g., by being pushed, pulled, downloaded or otherwise transferred) and made available for immediate use, storage for later use, etc.

As will be appreciated, disclosed are methods of restricting use and/or access to content stored by an electronic equipment that places an obligation on the user to take some action before being able to use or access the content in whole or in part. The management of content access is placed on the electronic equipment, rather than on a remotely located server. By rendering content management on the electronic equipment, server load can be reduced, bandwidth dedicated to content access functions in a communications network can be reduced and/or the user has greater control over the actions he or she is willing to take to access the content and such decision can be made on a content by content basis.

The functionality relating the management of content and enforcing obligations associated with content can be embodied as the content obligation enforcement function 22 and/or as part of the content itself. As indicated, such functionality and any corresponding functions of a remote device or server can be embodied in any suitable form, including software, firmware, dedicated circuit components, computer readable media, machine usable medium and so forth. Further, although the illustrations appended hereto that show a specific order of executing functional logic blocks, the order of execution of the blocks can be changed relative to the order shown. Also, two or more blocks shown in succession can be executed concurrently or with partial concurrence. Certain blocks may also be omitted. In addition, any number of commands, state variables, semaphores, or messages can be added to the logical flow for purposes of enhanced utility, accounting, performance, measurement, troubleshooting, and the like. It is understood that all such variations are within the scope of the present invention.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of managing content in a portable electronic equipment, comprising:
receiving content with the portable electronic equipment, the content having a use restriction that is liftable by user action with the portable electronic equipment to satisfy a user obligation associated with the content;
receiving input from the user consistent with the user action to satisfy the user obligation; and
liffing the use restriction to give the user access to the content, the lifting carried out by the portable electronic equipment upon satisfaction of the user obligation.

2. The method of claim 1, wherein the portable electronic equipment has wireless communication capability and a memory for storing the content.

3. The method of claim 1, wherein the portable electronic equipment is a mobile telephone.

4. The method of claim 1, wherein the user action is the transmission of a text message.

5. The method of claim 4, wherein the text message has a particular content and is transmitted to a particular destination to satisfy the obligation.

6. The method of claim 1, wherein the user action is the generation of a data call.

7. The method of claim 1, wherein the user action is the entry of an access code.

8. The method of claim 7, wherein the access code is acquired by the user upon the purchase of an item.

9. The method of claim 8, wherein the item is the content received by the portable electronic equipment.

10. The method of claim 8, wherein the item is merchandise acquired by the user separately from the content.

11. The method of claim 1, wherein the user action is submission of a payment.

12. The method of claim 11, wherein the payment submission includes making a short range transmission associated with a local payment scheme.

13. The method of claim 1, wherein the user action is transmission of the content from the portable electronic equipment to another electronic equipment.

14. The method of claim 1, wherein the user action is playing back another content associated with the content having the use restriction.

15. The method of claim 1, wherein the user action is taking a photograph with the portable electronic equipment.

16. The method of claim 1, further comprising prompting the user for the input upon an attempt by the user to access the content.

17. The method of claim 15, further comprising deleting the content if the user does not enter the input or declines to enter the input following prompting of the user.

18. The method of claim 15, wherein the prompting provides the user with a choice of plural actions to satisfy the obligation.

19. The method of claim 1, flurther comprising executing a plug-in to manage the user obligation.

20. The method of claim 1, further comprising using a SIM card to satisfy the user obligation.

21. The method of claim 1, wherein satisfying the user obligation lifts the use restriction indefinitely.

22. The method of claim 1, further comprising imposing the user obligation each time the user attempts to access the content.

23. The method of claim 1, further comprising imposing the user obligation during use of the content or periodically to permit continuing user access to the content.

24. A portable electronic equipment, comprising:
a user input device; and
a memory that contains a content having a data structure that includes:
a file containing at least one of audio data, video data, text data or executable instructions; and
a use restriction liftable by the portable electronic equipment upon receipt of user input via the user input device and that satisfies a user obligation associated with the content.

25. A program stored on a machine usable medium, the program including a content obligation enforcement function for a portable electronic equipment having a memory for storing content, comprising executable logic to:
receive content with the portable electronic equipment, the content having a use restriction that is liftable by user action with the portable electronic equipment to satisfy a user obligation associated with the content;
prompt the user for the user action;
lift the use restriction upon user action to satisfy the user obligation to give the user access to the content.

26. The program of claim 25, wherein the portable electronic equipment is a mobile telephone.
